(19) United States
(12) Patent Application Publication
(10) Pub. No.: US 2011/0074803 A1
(43) Pub. Date: Mar. 31, 2011

(54) Methods and Systems for Ambient-Illumination-Selective Display Backlight Modification and Image Enhancement

(76) Inventor: Louis Joseph Kerofsky, Camas, WA (US)

(21) Appl. No.: 12/569,853

(22) Filed: Sep. 29, 2009

(51) Int. Cl. G09G 5/02

(52) U.S. Cl. 345/589

(57) ABSTRACT

Aspects of the present invention comprise systems and methods for determining image content characteristics, determining ambient illumination conditions, selecting an initial backlight level based on the image content characteristics and selecting a backlight compensation process to be applied to the image based on the initial backlight level. Some aspects further relate to modification of the initial backlight level based on ambient illumination conditions and some aspects further relate to modification of the image with a second process based on ambient conditions.

### FIELD OF THE INVENTION

Embodiments of the present invention comprise methods and systems for determination of a backlight illumination level and a corresponding tone scale curve for image enhancement. In some embodiments, backlight selection and tone scale determination are dependent on at least one of image content and ambient illumination conditions.

### BACKGROUND

A viewer's visual system adapts based upon the lighting using during viewing. A display operating in low ambient conditions can be dimmer, using lower power, than when operating in a nominal ambient light level.

### SUMMARY

Some embodiments of the present invention comprise methods and systems for determining image content characteristics, determining ambient illumination conditions, selecting an appropriate backlight level based on the image content characteristics and the ambient illumination conditions and selecting a tone scale curve for image enhancement wherein the tone scale curve is intended to enhance the image for display under the ambient illumination conditions using the selected backlight level.

Some embodiments comprise systems and methods wherein a image characteristics and ambient conditions are determined and an initial backlight setting is determined based on image characteristics. The image is then compensated for the initial backlight setting. The backlight is then adapted or adjusted to the ambient conditions while the image is maintained as it was compensated for the initial backlight setting. This process may result in display of the image with additional brightness due to an increased backlight setting above that used for image compensation.

Some embodiments comprise systems and methods wherein a image characteristics and ambient conditions are determined and an initial backlight setting is determined based on image characteristics. The image is then compensated for the initial backlight setting. The backlight is then adapted or adjusted to the ambient conditions. The image is also adapted to ambient conditions by application of a tone scale curve, gain function of some other process that may affect the brightness of the image. This process may result in display of the image with additional brightness due to an increased backlight setting above that used for image compensation as well as additional ambient-related image compensation above the initial backlight-related image compensation.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a figure showing how perceived brightness is surround-dependent;

FIG. 2 is a chart showing an exemplary system comprising a perceptual brightness model, perceptual reference and a display model;

FIG. 3 is a graph showing perceptual black as a function of a surround characteristic;

FIG. 4 is a chart showing an exemplary process for developing a perceptual brightness model;

FIG. 5 is a chart showing an exemplary process for display adjustment with a surround-specific display model;

FIG. 6 is a chart showing an exemplary process for image processing with a surround-specific display model;

FIG. 7 is a chart showing an exemplary process for application of a surround-specific display model;

FIG. 8 is a diagram showing exemplary white point selection models;

FIG. 9 is a chart showing power consumption vs. backlight settings;

FIG. 10 is a chart showing tone scale curves that match perceived lightness for varying ambient conditions;

FIG. 11 is a diagram showing an exemplary embodiment of the present invention comprising an image-dependent preliminary backlight selection and ambient-dependent backlight modification;

FIG. 12A is a chart with log-log scale showing exemplary tone scale curves for a low ambient condition;

FIG. 12B is a chart with linear scale showing exemplary tone scale curves for a low ambient condition;

FIG. 13A is a chart with log-log scale showing exemplary tone scale curves for a mid ambient condition;

FIG. 13B is a chart with linear scale showing exemplary tone scale curves for a mid ambient condition;

FIG. 14A is a chart with log-log scale showing exemplary tone scale curves for a bright ambient condition;

FIG. 14B is a chart with linear scale showing exemplary tone scale curves for a bright ambient condition;

FIG. 15 is a diagram showing an exemplary embodiment of the present invention comprising an image-dependent and ambient-dependent backlight selection module;

FIG. 16 is a chart showing steps of an exemplary process comprising backlight level selection based on image content and modification of the backlight selection based on ambient conditions;

FIG. 17 is a chart showing steps of an exemplary process comprising backlight selection based on image content and ambient conditions; and

FIG. 18A is a chart showing steps of an exemplary process comprising tone scale curve selection based on image content and ambient conditions;

FIG. 18B is a continuation of the chart in FIG. 18A;

FIG. 19 is a diagram showing an exemplary image enhancement system comprising an ambient sensor;

FIG. 20 is a diagram showing an exemplary image enhancement system comprising an ambient-related backlight gain module;

FIG. 21 is a diagram showing an exemplary image enhancement system comprising an ambient-related backlight gain module and a an ambient enhancement module;

FIG. 22 is a plot showing exemplary gain functions for backlight modification;

FIG. 23 is a chart showing steps of an exemplary process comprising determination of an ambient-adapted backlight setting;

FIG. 24 is a chart showing steps of an exemplary process comprising enhancing a backlight compensated image for ambient conditions; and

FIG. 25 is a chart showing steps of an exemplary process comprising selective enhancement of a backlight compensated image based on ambient conditions.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Some embodiments of the present invention may comprise elements that are described in the following pending patent applications and issued patents, which are hereby incorporated herein by reference.
U.S. patent application Ser. No. 11/154,052, entitled “Methods and Systems for Enhancing Display Characteristics,” filed on Jun. 15, 2005, published as U.S. publication No. 2006-0284822 on Dec. 21, 2006
U.S. patent application Ser. No. 11/154,053, entitled “Methods and Systems for Enhancing Display Characteristics with High-Frequency Contrast Enhancement,” filed on Jun. 15, 2005, published as U.S. publication No. 2006-0284882 on Dec. 21, 2006
U.S. patent application Ser. No. 11/154,054, entitled “Methods and Systems for Enhancing Display Characteristics with Frequency-Specific Gain,” filed on Jun. 15, 2005, published as U.S. publication No. 2006-0284823 on Dec. 21, 2006
U.S. patent application Ser. No. 11/224,792, entitled “Methods and Systems for Image-Specific Tone Scale Adjustment and Light-Source Control,” filed on Sep. 12, 2005, published as U.S. publication No. 2006-0119612 on Jun. 8, 2006
U.S. patent application Ser. No. 11/202,903, entitled “Methods and Systems for Independent View Adjustment in Multiple-View Displays,” filed on Aug. 8, 2005, published as U.S. publication No. 2007-0035565 on Feb. 15, 2007
U.S. patent application Ser. No. 11/371,466, entitled “Methods and Systems for Enhancing Display Characteristics with Ambient Illumination Input,” filed on Mar. 8, 2006, published as U.S. publication No. 2007-0211049 on Sep. 13, 2007
U.S. patent application Ser. No. 11/293,562, entitled “Methods and Systems for Determining a Display Light Source Adjustment,” filed on Dec. 2, 2005, published as U.S. publication No. 2006-0209003 on Sep. 21, 2006
U.S. patent application Ser. No. 11/293,066, entitled “Methods and Systems for Display Mode Dependent Brightness Preservation,” filed on Dec. 2, 2005, published as U.S. publication No. 2006-0119613 on Jun. 8, 2006
U.S. patent application Ser. No. 11/460,768, entitled “Methods and Systems for Distortion-Related Source Light Management,” filed on Jul. 28, 2006, published as U.S. publication No. 2006-0262111 on Nov. 1, 2007
U.S. patent application Ser. No. 11/460,907, entitled “Methods and Systems for Generating and Applying Image Tone Scale Corrections,” filed on Jul. 28, 2006, published as U.S. publication No. 2006-0267923 on Nov. 30, 2006
U.S. patent application Ser. No. 11/460,940, entitled “Methods and Systems for Color Preservation with Image Tonescale Corrections,” filed on Jul. 28, 2006, published as U.S. publication No. 2008-0024517 on Jan. 31, 2008, issued as U.S. Pat. No. 7,515,160 on Apr. 7, 2009
U.S. patent application Ser. No. 11/465,436, entitled “Methods and Systems for Selecting a Display Source Light Illumination Level,” filed on Aug. 17, 2006, published as U.S. publication No. 2006-0274026 on Dec. 7, 2006
U.S. patent application Ser. No. 11/564,203, entitled “Methods and Systems for Image Tonescale Adjustment to Compensate for a Reduced Source Light Power Level,” filed on Nov. 28, 2006, published as U.S. publication No. 2007-0092139 on Apr. 26, 2007
U.S. patent application Ser. No. 11/680,312, entitled “Methods and Systems for Brightness Preservation Using a Smoothed Gain Image,” filed on Feb. 28, 2007, published as U.S. publication No. 2007-0146236 on Jun. 28, 2007
U.S. patent application Ser. No. 11/680,539, entitled “Methods and Systems for Surround-Specific Display Modeling,” filed on Feb. 28, 2007, published as U.S. publication No. 2008-0208551 on Aug. 28, 2008
U.S. patent application Ser. No. 11/845,651, entitled “Methods and Systems for Tone Curve Generation, Selection and Application,” filed on Aug. 27, 2007, published as U.S. publication No. 2007-0291048 on Dec. 20, 2007
U.S. patent application Ser. No. 11/929,796, entitled “Methods and Systems for Backlight Modulation and Brightness Preservation,” filed on Oct. 30, 2007, published as U.S. publication No. 2009-0109232 on Apr. 30, 2009
U.S. patent application Ser. No. 11/929,918, entitled “Methods and Systems for Image Enhancement,” filed on Oct. 30, 2007, published as U.S. publication No. 2009-0109233 on Apr. 30, 2009
U.S. patent application Ser. No. 11/948,969, entitled “Methods and Systems for Weighted-Error-Vector-Based Source Light Selection,” filed on Nov. 30, 2007, published as U.S. publication No. 2009-0140970 on Jun. 4, 2009
U.S. patent application Ser. No. 11/948,978, entitled “Methods and Systems for Backlight Modulation with Scene-Cut Detection,” filed on Nov. 30, 2007, published as U.S. publication No. 2009-0141178 on Jun. 4, 2009
U.S. patent application Ser. No. 11/964,674, entitled “Methods and Systems for Display Source Light Illumination Level Selection,” filed on Dec. 26, 2007
U.S. patent application Ser. No. 11/964,683, entitled “Methods and Systems for Backlight Modulation with Image Characteristic Mapping,” filed on Dec. 26, 2007
U.S. patent application Ser. No. 11/964,689, entitled “Methods and Systems for Display Source Light Management with Histogram Manipulation,” filed on Dec. 26, 2007
U.S. patent application Ser. No. 11/964,691, entitled “Methods and Systems for Image Tonescale Design,” filed on Dec. 26, 2007
U.S. patent application Ser. No. 11/964,695, entitled “Methods and Systems for Display Source Light Management with Variable Delay,” filed on Dec. 26, 2007
U.S. patent application Ser. No. 12/111,113, entitled “Methods and Systems for Image Compensation for Ambient Conditions,” filed on Apr. 28, 2008
U.S. patent application Ser. No. 12/202,243, entitled “Methods and Systems for Display Source Light Management with Rate Change Control,” filed on Aug. 30, 2008
U.S. patent application Ser. No. 12/497,090, entitled “Methods and Systems for Ambient-Adaptive Image Display,” filed on Jul. 2, 2009

Some embodiments of the present invention comprise methods and systems for constructing and applying a family of display models which yield similar perceived display values in different ambient viewing environments. Application of this family of perceptual displays may result in a desired display output under different ambient light levels. In some embodiments, these methods and systems may be used to control the display process, e.g., backlight selection in an LCD.

In some embodiments of the present invention, the systems and methods use a specified display in a specified surround luminance to construct a reference for the perceptual model. Some embodiments use this reference, the perceptual model and a different surround environment to construct a display scenario having the same perceptual properties in the new surround as the reference display has in the reference surround. Thus, the perceptual model produces a display which will preserve one or more perceptual properties despite changes in the ambient surround. In some embodiments, the preserved perceptual properties may comprise black level, black level and white point, black level white point and intermediate gray levels, or other combinations of these properties or similar properties.

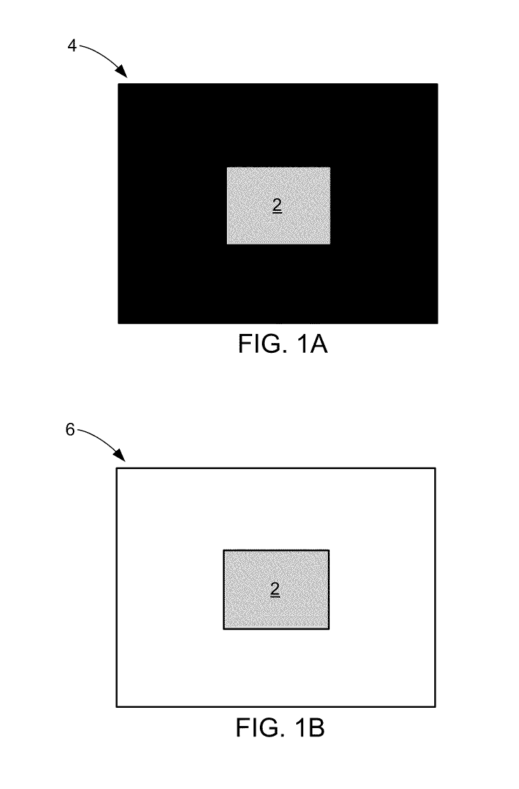

It is well known that the luminance of the surround of a display influences the perception of the image on the display. A simple example is illustrated in FIGS. 1A and 1B where the appearance of the same display in different surround luminance levels is illustrated. In FIG. 1A, a flat grayscale image 2 is shown in a dark surround 4. In FIG. 1B, the same flat grayscale image 2 is shown in a light surround 6. Note how the grayscale image 2 appears brighter in the dark surround 4 of FIG. 1A than it does in the light surround 6 of FIG. 1B. This same phenomenon occurs in displayed images with varying surround conditions. The elevation of black level commonly seen in an LCD is illustrated by these figures.

The example shown in FIGS. 1A and 1B illustrates that the perception of the display output depends upon the viewing conditions. Embodiments of the present invention may use a model of brightness perception together with a measurement of the viewing conditions to maintain perceived image qualities such as black level. In some embodiments, desired qualities may comprise: perceived black level, perceived black level and white point or multiple perceived tonescale points.

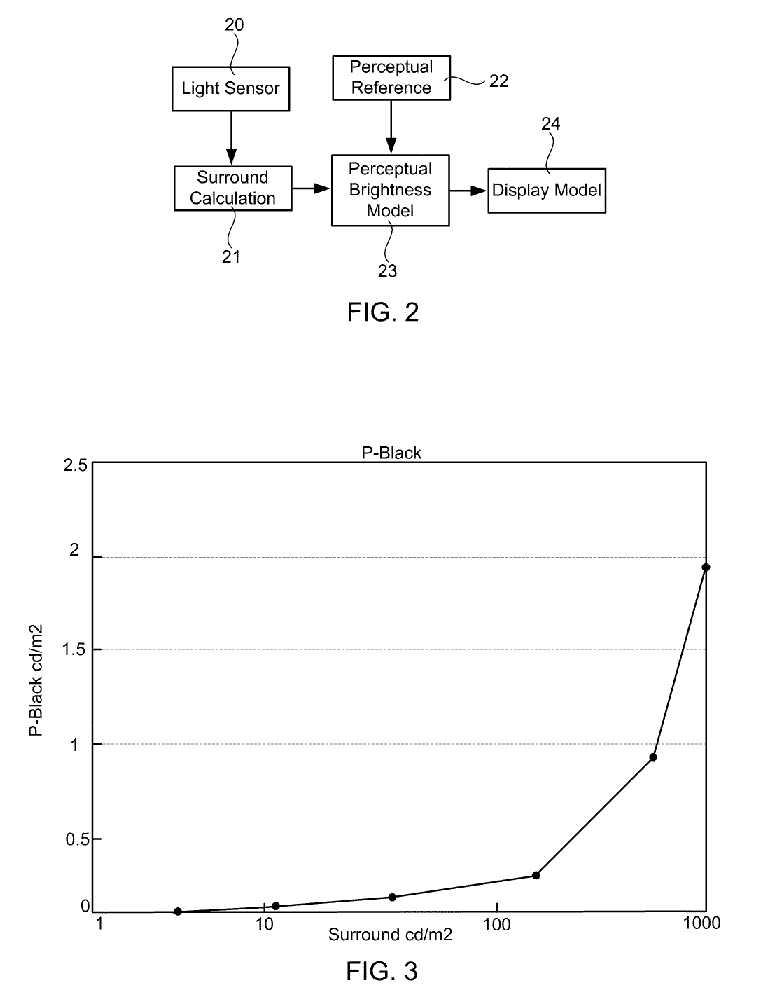

FIG. 2 is a block diagram showing the elements of some embodiments of the present invention and their interaction. These embodiments comprise a light sensor 20 which may sense the ambient light conditions around a display. In some embodiments, light sensor 20 may sense light incident on the front of the display, light reflected off the background of the display, light incident on the side of the display or may perform another light measurement related to the ambient light in a display environment. In some embodiments, light sensor 20 may comprise multiple light sensors at various locations in proximity to the display. In some embodiments, light sensor 20 may detect light in the visible spectrum. In some embodiments, light sensor 20 may detect light outside the visible spectrum, which may be indicative of visible light characteristics in the surrounding environment. In some embodiments, light sensor 20 may detect light color characteristics. In some embodiments, light sensor 20 may input information into a surround calculation module 21.

Some embodiments of the present invention may comprise a surround calculation module 21. Surround light information may be sent from the light sensor to the surround calculation module 21. However, raw light sensor data received from the light sensors 20 may not be directly indicative of display surround conditions. Depending on the orientation and location of the sensor(s) 20, light sensor data may need to be processed. For example, a front-facing light sensor may detect light incident on the front of the display, but may not reflect information relative to the reflectivity of the background surrounding the display. Environmental factors, such as reflectivity of surrounding surfaces, proximity of surrounding surfaces, orientation of surrounding surfaces, texture of surrounding surfaces and other information may, in some embodiments, be input to the surround calculation module 21 to determine the characteristics of the surround environment. This information may be input manually by a user/installer or may be detected by automated sensing equipment. In some embodiments, only information received from the light sensor 20 is needed for the surround calculation 21.

In some exemplary embodiments, a front-facing sensor may be used for the light sensor 20. This sensor 20 may measure the light incident on the display, but not the surround directly. The surround luminance may differ from the sensed light due to the unknown wall reflectance. However, a reflectance can be assumed based on typical or conservative values. In some embodiments, this may be calibrated by using a typical room measuring the surround luminance and the ambient light sensed. In other embodiments, user adjustment of a reflectance factor may be used to more accurately predict surround surface reflectance. This reflectance information may be used to calculate surround conditions in surround calculation module 21.

In some exemplary embodiments, a rear facing sensor may be used for a light sensor 20 measures light reflected off wall toward rear of set. This sensor orientation can provide a direct measure of the surround luminance, but may suffer if the rear of the set is blocked such as when a display is wall mounted or in a cabinet. When the display is not blocked, these embodiments may omit surround calculation module 21 or calculation therein and use raw light sensor data to select a perceptual brightness model 23.

In some exemplary embodiments a rear-angled sensor may be used. A sensor in this orientation may measure light reflected from the side of the set, typically toward the back. These embodiments may reduce some of the problems of the rear facing sensors and typically work well for a wall mounted display.

In some exemplary embodiments, multiple sensors may be used. Some embodiments may comprise both a front sensor and a rear sensor. These embodiments have the benefit of not needing a reflection estimate when the rear sensor is receiving sufficient light. In some embodiments, when the rear sensor is blocked, e.g. the display is in a cabinet, the front facing sensor may be used.

Some embodiments of the present invention comprise a display model 24. A display model 24 may comprise a description of output luminance as a function of input code value supplied to the model display. In some embodiments, the basic model may comprise a Gain-Offset-Gamma (GoG) model to describe a display output. The form of this model in terms of luminance at black (B) and the luminance at white (W) is given in Equation 1 below. The value 2.2 is typically used for the parameter gamma.

$$GoG Display Model$$

$$L ( cv ) = {( ( {W}^{\frac{1}{γ}} - {B}^{\frac{1}{γ}} ) \cdot cv + {B}^{\frac{1}{γ}} )}^{γ} \qquad Equation 1$$

In some embodiments, this model can be additionally modified by specifying a tonescale in addition to the black and white levels. Some embodiments may comprise a tone scale T(cv) that may be applied to the code values prior to using the GoG model of Equation 1. Allowing the specification of a tone scale allows any display model with specified black and white points to be described through the GoG model. In some embodiments, the display model may be specified by two numbers, black and white luminances, and may be modified by additionally specifying a tonescale. The general form of this model is shown in Equation 2.

$$Tone scale modified GoG Display Model$$

$$L ( cv ) = {( ( {W}^{\frac{1}{γ}} - {B}^{\frac{1}{γ}} ) \cdot T ( cv ) + {B}^{\frac{1}{γ}} )}^{γ} \qquad Equation 2$$

Some embodiments of the present invention may comprise a perceptual reference 22. The perceptual reference 22 may specify a single surround and the desired display in this surround. This serves as an anchor with model displays in other surround luminances determined based upon the perceptual reference and reference surround. The perceptual reference 22 may be specified by giving a reference surround luminance and specifying the display model data (e.g., black level, white point, and/or tonescale) in this surround luminance (Surround_{R}). An exemplary perceptual reference is shown in Equation 3. This exemplary reference may be generated by measuring the tonescale of a desired display in a reference surround or by individually specifying parameters such as reference black and white levels. In some embodiments, these could be ideal values not simultaneously achievable by an actual display.

$$Perceptual Reference$$

$${Surround}_{R} \\ {L}_{R} ( cv ) = {( ( {W}_{R}^{\frac{1}{γ}} - {B}_{R}^{\frac{1}{γ}} ) \cdot {T}_{R} ( cv ) + {B}_{R}^{\frac{1}{γ}} )}^{γ} \qquad Equation 3$$

Some embodiments of the present invention may comprise a perceptual brightness model 23. In some exemplary embodiments, three different levels of model may be defined according to the perceptual properties preserved in constructing the display model. In exemplary level 1, only the perceptual black level is preserved. Hence, the perceptual model consists of a luminance level for perceptual black as a function of surround luminance In exemplary level 2, both the perceptual black level and perceptual white point are preserved. Hence, the perceptual model consists of a luminance level for perceptual black and a luminance level for perceptual white both as functions of surround luminance In exemplary level 3, the perception of multiple gray levels may be preserved. Hence, in some embodiments, this perceptual model may describe luminance for perceptually equal luminance levels as a function of surround luminance

### Exemplary Model Level 1

In these embodiments, only the perceptual black level is considered. The perceptual model comprises a luminance level giving perceptual black for each surround luminance Data from a psychophysical experiment on perceived black level as a function of surround luminance is shown in 3. This data indicates the display luminance below which a viewer perceives black as a function of the luminance of the display surround. As expected the luminance necessary to provide perceived black decreases as the surround luminance decreases.

In developing this exemplary display model, a fixed contrast ratio (CR) may be assumed. The display model may be determined entirely by the black level. In some embodiments, the backlight necessary to achieve perceived black, in a display with fixed contrast ratio (CR), which keeps a perceptual black, may be described by Equation 4.

$$Level 1 Reference Display$$

$$W ( S ) = CR \cdot B ( S ) \\ L ( cv , S ) = {( {B ( S )}^{\frac{1}{γ}} \cdot ( CR - 1 ) \cdot cv + {B ( S )}^{\frac{1}{γ}} )}^{γ} \\ L ( cv , S ) = \frac{B ( S )}{CR} \cdot {( ( 1 - \frac{1}{CR} ) \cdot cv + \frac{1}{CR} )}^{γ} \qquad Equation 4$$

The backlight level is the ratio of the surround dependent black level, B(S), and the fixed contrast ratio CR.

### Exemplary Model Level 2

In these embodiments, both the perceptual black level and perceptual white point may be considered. The perceptual model may comprise luminance levels giving constant perceptual black and constant perceptual white point as a function of surround luminance Unlike the perceptual black level, the perceptual white point may not be uniquely defined and may require the selection of a reference, e.g., specification of a surround and the luminance of perceptual white in this surround. For perceptual white, a surround and a luminance for use as a reference may be selected. A perceptual model may be used to determine the luminance level giving equal perceived brightness. This defines a perceptual white luminance as function of surround luminance In some embodiments, the Bartleson model of perceived brightness may be used. This model is described in Bartleson, “Measures of Brightness and Lightness”, Die Farbe 28 (1980); Nr 3/6, which is incorporated herein by reference. In some embodiments, an experimental determination of perceptual white as a function of surround luminance may be used. Given Black(S) and White(S), the reference display as a function of surround may be given by a GoG model with specified black and white levels.

$$Level 2 Reference Display$$

$$L ( cv , S ) = {( ( {W ( S )}^{\frac{1}{γ}} - {B ( S )}^{\frac{1}{γ}} ) \cdot cv + {B ( S )}^{\frac{1}{γ}} )}^{γ} \qquad Equation 5$$

### Exemplary Model Level 3

In these exemplary embodiments, the brightness perception of all grey levels may be considered. The display model of exemplary model level 2 will may be modified by specifying a tone scale in addition to the black and white levels. The perceptual model may comprise luminance levels giving perceptual match to each grey level as perceived in a reference surround. In some embodiments, the Bartleson model may again be used to determine such a mapping. The Bartleson model for a display in surround S showing a luminance value L can be summarized by the form P(L,S) shown below Equation 6. The expressions a(S) and b(S) are expressed in detail in the incorporated Bartleson reference.

$$Form of Bartleson [ 1980 ]$$

$$P ( L , S ) = a ( S ) \cdot {L}^{\frac{1}{3}} + b ( S ) \qquad Equation 6$$

Analysis of the Bartleson model determines criteria for luminance values. A brief illustration of this derivation is shown below. Given two surrounds S1 and S2, assume luminances (B1,W1) and (B2,W2) have been determined giving equal perceived black and white in the corresponding surrounds as in the exemplary model level 2 description above. In the notation below, black and white levels giving perceptual match in two surrounds are denoted by B₁ B₂ and W₁ W₂ respectively. It can be shown that intermediate luminance values are related by the following expression irrespective of the expressions for a(S) and b(S) in the model of Equation 6. The result relating luminance values is summarized in Equation 7. This relates the output at corresponding grey levels. A perceptual matching tonescale function can be derived based on the GoG model of Equation 2.

$$Condition for matching output of Bartleson [ 1980 ] model$$

$${L}_{2}^{\frac{1}{3}} = \frac{{W}_{2}^{\frac{1}{3}} - {B}_{2}^{\frac{1}{3}}}{{W}_{1}^{\frac{1}{3}} - {B}_{1}^{\frac{1}{3}}} \cdot {L}_{1}^{\frac{1}{3}} + \frac{{W}_{2}^{\frac{1}{3}} \cdot {B}_{1}^{\frac{1}{3}} - {W}_{1}^{\frac{1}{3}} \cdot {B}_{2}^{\frac{1}{3}}}{{W}_{2}^{\frac{1}{3}} - {B}_{2}^{\frac{1}{3}}} \\ {L}_{2}^{\frac{1}{3}} \approx \frac{{W}_{2}^{\frac{1}{3}}}{{W}_{1}^{\frac{1}{3}}} \cdot {L}_{1}^{\frac{1}{3}} + {B}_{1}^{\frac{1}{3}} - \frac{{W}_{1}^{\frac{1}{3}}}{{W}_{2}^{\frac{1}{3}}} \cdot {B}_{2}^{\frac{1}{3}} \qquad Equation 7$$

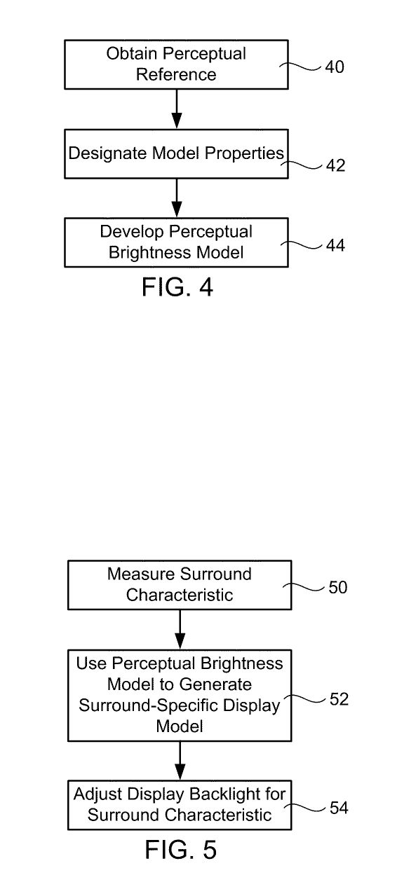

Some embodiments of the present invention may be described with reference to FIG. 4. In these embodiments, a perceptual reference is obtained 40. The perceptual reference may be specified by a reference surround luminance and display model data (e.g., black level, white point, and/or tonescale) in this surround luminance. In some embodiments, this reference may be generated by measuring the tonescale of a desired display in a reference surround or by individually specifying parameters such as reference black and white levels. In these embodiments, model properties may also be designated 42. These properties may be designated by user input or may be otherwise selected at some time before creation of the model. In some embodiments, model properties may comprise a black level, a white point and/or a tonescale. In some embodiments, pre-set model property sets may be selected, e.g., model levels 1-3, described above.

These model properties and the perceptual reference may be used to develop a perceptual brightness model 44, which may be used to establish a relationship between surround conditions and display parameters, such as display backlight level, and other parameters. The perceptual brightness model 44 may also be used to establish a relationship between surround conditions and image parameters and values. This relationship may be represented as a tonescale or white point mapping. In some embodiments, the perceptual brightness model 44 may be coupled with surround conditions to generate a display model.

Some embodiments of the present invention may be described with reference to FIG. 5. In these embodiments, a sensor may be used to measure 50 a surround characteristic or condition. In some embodiments, the surround characteristic may be related to the intensity of light incident on a display. In some embodiments, the measured surround characteristic may be processed or used as input for a calculation that yields a more relevant surround characteristic.

The measured or calculated surround characteristic may then be input to a perceptual brightness model, which may be used to generate 52 a surround-specific display model. The display model may comprise data, which establishes a backlight illumination level corresponding to a black level appropriate for the measured surround characteristic. This display model data may then be used to adjust 54 a display backlight to produce the corresponding black level.

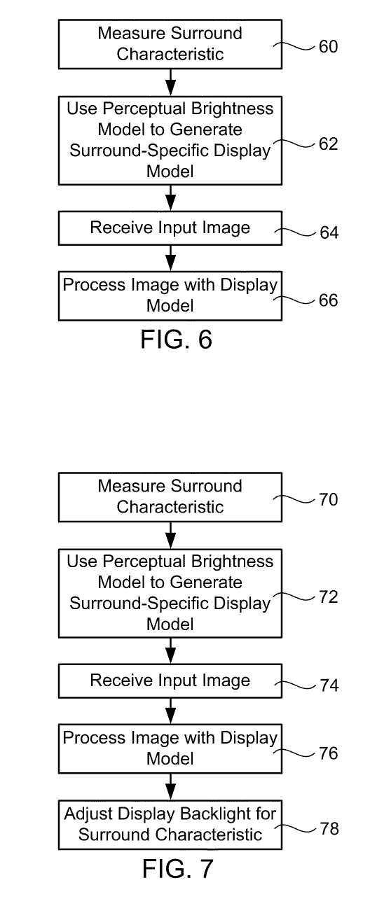

Some embodiments of the present invention may be described with reference to FIG. 6. In these embodiments, a sensor may be used to measure 60 a surround characteristic or condition. In some embodiments, the surround characteristic may be related to the intensity of light incident on a display. In some embodiments, the measured surround characteristic may be processed or used as input for a calculation that yields a more relevant surround characteristic.

The measured or calculated surround characteristic may then be input to a perceptual brightness model, which may be used to generate 62 a surround-specific display model. The display model may comprise data that relates an input image code value to a display output value. In some embodiments, the display model may relate an input code value to a white point. In some embodiments, the display model may comprise a tonescale operation.

In some embodiments, an input image may be received 64 and processed 66 with the display model. In some embodiments, this process may comprise mapping image data to a white point. In some embodiments, this process may comprise application of a tonescale operation to image data.

Some embodiments of the present invention may be described with reference to FIG. 7. In these embodiments, a sensor may be used to measure 70 a surround characteristic or condition. In some embodiments, the surround characteristic may be related to the intensity of light incident on a display. In some embodiments, the measured surround characteristic may be processed or used as input for a calculation that yields a more relevant surround characteristic.

The measured or calculated surround characteristic may then be input to a perceptual brightness model, which may be used to generate 72 a surround-specific display model. The display model may comprise data that relates an input image code value to a display output value. In some embodiments, the display model may relate an input code value to a white point. In some embodiments, the display model may comprise a tonescale operation. The display model may also comprise data, which establishes a backlight illumination level corresponding to a black level appropriate for the measured surround characteristic.

In some embodiments, an input image may be received 74 and processed 66 with the display model. In some embodiments, this process may comprise mapping image data to a white point. In some embodiments, this process may comprise application of a tonescale operation to image data. The display model data may also be used to adjust 78 a display backlight to produce a black level identified by the display model.

### White Point Selection

Some embodiments of the present invention operate within the confines of a limited achievable display range to achieve lightness matching where possible. Where lightness matching is not possible, due to upper limit on display maximum brightness or lower limit on display black level, the contrast of the displayed image is preserved. The algorithm operates to select a desired display response, or tone curve, as a function of ambient light level. In some embodiments, this desired tone curve may be allowed to exceed the actual limits of the display.

In some embodiments, the image content to be displayed may be analyzed to select a relative reduced backlight and corresponding brightness preserving tone scale or gain. The desired tone curve, the selected brightness preserving tonescale, and the backlight capabilities of the display may be combined to select the actual backlight level used with the display. In some embodiments, the image is modified by the selected brightness preserving tonescale or gain and the backlight is set to a level which most nearly approximates the desired display lightness output.

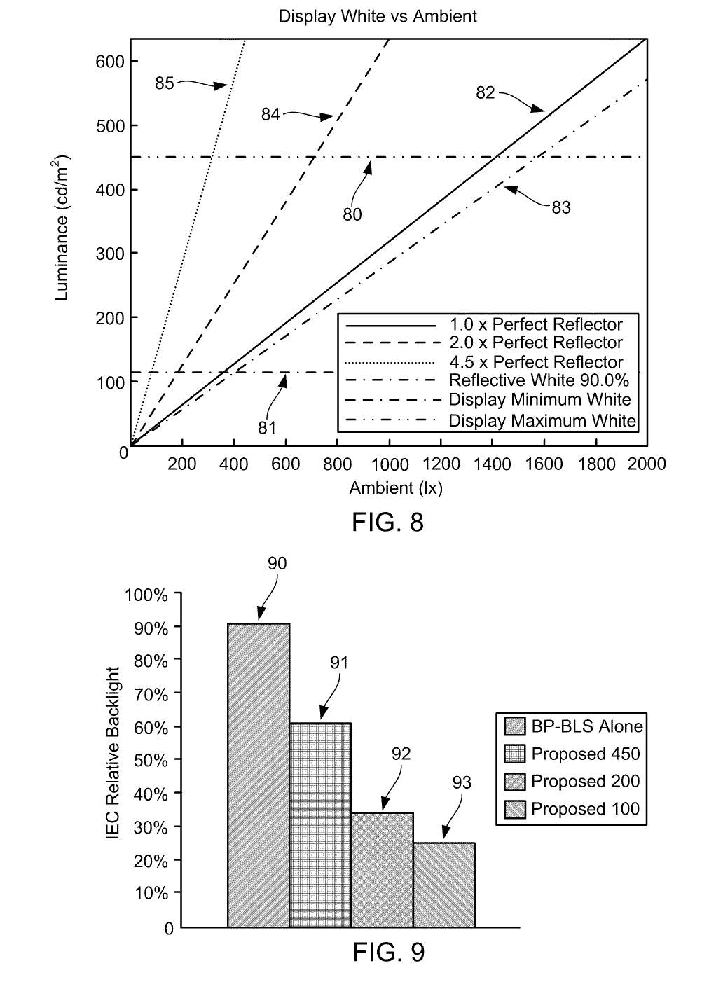

Some embodiments of the present invention select the white point based on the ambient light level and a linear model. The slope of the linear model may be chosen greater than 1 so that the display white is larger than that of an ideal diffuse reflecting surface. In these embodiments, the display white is selected according to this model and the perceptual matching approach described above may be applied. FIG. 8 illustrates several exemplary linear models for white point selection. In FIG. 8, the upper horizontal line 80 represents a display maximum white luminance and lower horizontal line 81 represents a display minimum white luminance Diagonal line 82 represents a perfect reflector with 100% reflectance and diagonal line 83 represents an exemplary reflective white with 90% reflectance. Exemplary model line 84 represents a model with 2× the perfect (100%) reflectance and exemplary model line 85 represents a model with 4.5× the perfect reflectance. FIG. 8 plots ambient illuminance in Lux (horizontal axis) with the luminance of a corresponding white point (vertical axis). The models represented by various model lines 82-85 in FIG. 8 may be used for selection of a white point that is dependent on ambient illumination.

Different choices of the scale factor in deciding the target display white point lead to different power consumption by the TV. The histogram shown in FIG. 9 presents average power consumption for several gain choices vs. an algorithm 90 which is non-adaptive to the ambient illumination. In these exemplary scenarios, bars 91-93 represent cases in which the white point is selected as a multiple of the ambient illuminance. The bars in FIG. 9 give average backlight used on the IEC video test sequence at different ambient points on a single exemplary curve of FIG. 8. For example, the 2.0X Perfect reflector curve may be used to generate this data at the points X=100 lx, 200 lx, and 450 lx. Note that bar 90 corresponds to un-ambient aware backlight selection with a maximum of 450 cd/m2, i.e. display maximum white. Bar 91 is roughly ⅔ of the height of bar 90 (60% vs 90%). At ambient of 450 lx, curve 84 is roughly ⅔ of the display maximum.

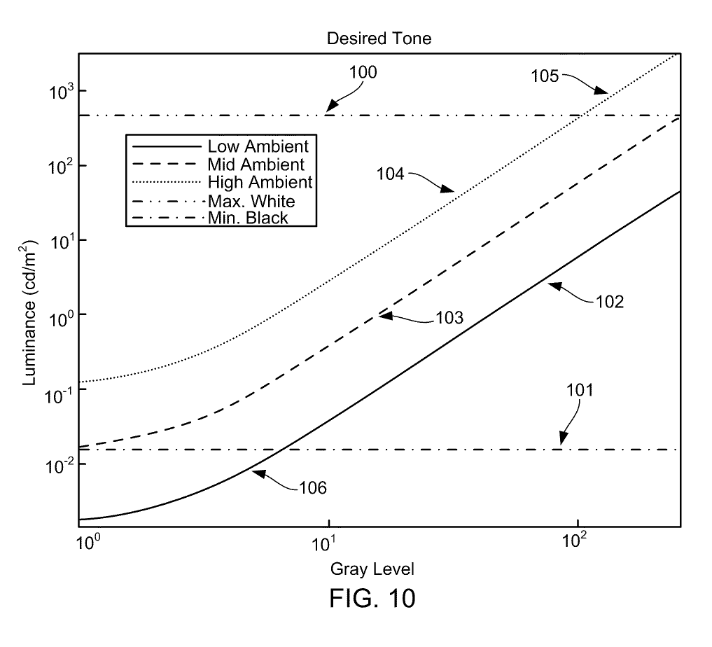

Exemplary tone curves needed to match lightness under different ambient light levels are shown in FIG. 10. In FIG. 10, a maximum display white level is shown as upper horizontal line 100 and a minimum display white level is shown a lower horizontal line 101. Exemplary tone curves 102-104 represent tone scale operations that will produce the same perceived lightness under different ambient conditions. Lower tone curve 102 may be used for a condition of low ambient luminance in order to achieve a target perceived lightness. Middle tone curve 103 may be used to achieve the same target perceived lightness under a condition of moderate ambient luminance Likewise, upper tone curve 104 may be used to achieve the same target perceived lightness as the other curves, but under a bright ambient luminance. These lower, middle and upper tone curves may be used as target tone curves for use as reference curves in generating tone curves for their respective ambient conditions.

Under some viewing conditions and image content combinations, the necessary display output to achieve a lightness match is outside of the display capabilities e.g. the display maximum output 100 may be too low in high ambient to represent a bright white 105 or the display's minimum output 101 may be too high to represent a dark black 106. The limits on the display output are generally ambient independent as shown by the horizontal lines 100, 101. However, these limits may become ambient dependent when they are related to a backlight level that is controlled in an ambient-dependant manner.

Note that the constraints may apply to different parts of the tone scale. For instance, in the high ambient condition, the maximum white constraint limits the ability to reach the desired output for bright content. For dark content however, this limit is not problematic. The ability to achieve the desired output is content dependant.

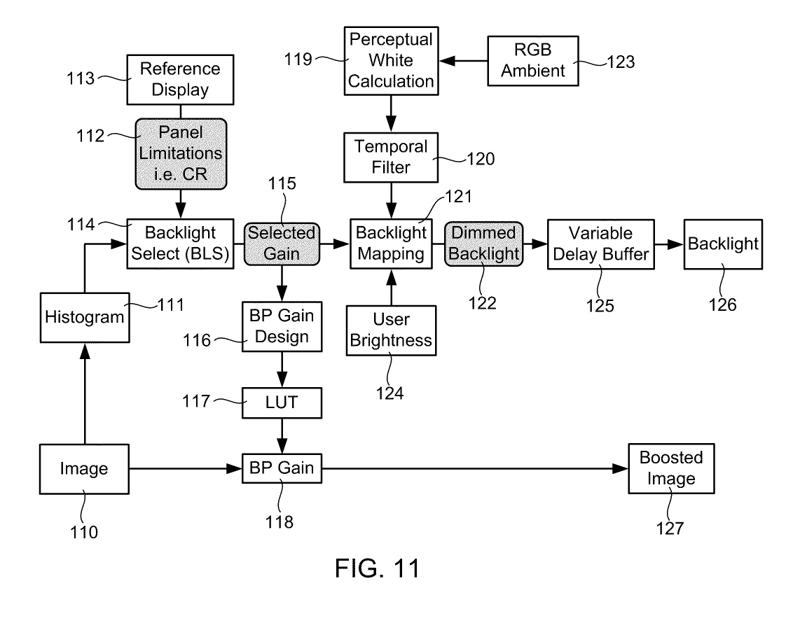

Some embodiments of the present invention may be described with reference to FIG. 11. In these embodiments, an image 110 may be provided to an image analysis module 111, which may calculate histogram data or other image data. The image 110 may also be provided to a brightness preservation (BP) gain module 118, where a tonescale and/or gain operation may be applied to the image 110. The image data generated by the image analysis module 111 may be sent to a backlight selection (BLS) module 114 for use in determining an appropriate backlight level for the image 110. The BLS module 114 may also receive data from a reference display module 113. The reference display module 113 may comprise a reference display model, which may be used to determine display output in relation to display input. A reference display module 113 may be used to store or determine display panel limitation data 112. Display panel limitation data 112 may comprise a display panel contrast ratio and may comprise contrast ratio data for various backlight settings or a model that generates contrast ratio data based on backlight setting.

Based on reference display module 113 input, such as display panel limitations 112, and image analysis module 111 input, the BLS module 114 may select a backlight setting or level that is appropriate for the display and the image 110. This selected backlight setting 115 may then be sent to a BP tonescale or gain design module 116, which may generate a tonescale or gain function or operation that will compensate the image 110 for the change in backlight setting performed by the BLS module 114.

The backlight selection 115 may also be sent to a backlight mapping module 121, which may adjust the backlight selection 115 to account for ambient illumination conditions. The system may comprise an ambient illumination sensor 123. In some embodiments, an ambient illumination sensor 123 may comprise an RGB color illumination sensor. In other embodiments, the ambient illumination sensor 123 may comprise simply a monochrome sensor or another type of color sensor. In some embodiments, the color channels of the ambient illumination sensor 123 may match those of the display panel pixels. The measurements of the ambient illumination sensor 123 may be sent to a perceptual white calculation module 119, which may use methods described herein to determine a perceived white point as well as other calculations. Output from the perceptual white calculation module 119 may comprise data for a plurality of image frames, which may be processed through a temporal filter 120 before being sent to the backlight mapping module 121. The temporal filter 120 may effect temporal smoothing or some other operation that limits the rate of change of data from the perceptual white calculation module 119.

The backlight mapping module 121 may also receive input from a user brightness selection module 124, which may receive user input indicating a preferred user brightness setting or preferred brightness range. Based on input from the perceptual white calculation module 119, the user brightness selection module 124 and the backlight selection data 115, the backlight mapping module 121 may determine an adjusted backlight level 122. This adjusted backlight level 122 is based on input from the ambient illumination sensor 123, which has been processed by the perceptual white calculation module 119 and, in some embodiments, a temporal filter 120. Using methods and systems described herein and in references incorporated herein by reference, the backlight mapping module 121 may determine an adjusted backlight level 122 that is appropriate for the perceived ambient illumination characteristics of the display environment.

The adjusted backlight level 122 may be sent to a delay buffer 125, which may be a variable delay buffer. This is performed to ensure that the adjusted backlight level 122 is employed at the backlight 126 at the time that a corresponding enhanced image 127 is displayed on the display panel.

When the BP tonescale or gain design module 116 has received the selected backlight setting 115, the BP tonescale or gain design module 116 may generate a tonescale or gain function or operation for compensating the image 110 for the effect of a backlight selection 115 that is non-standard or below the typical 100% output. The tonescale or gain operation may be generated by methods and/or systems described herein or in references incorporated herein by reference. This tonescale or gain operation may 117 may be generated as a look-up table (LUT) or some other structure or operation. The tonescale or gain operation 117 may be applied 118 to the image 110 resulting in an enhanced image 127 that will be displayed with a backlight using the adjusted, and in some cases delayed, backlight setting determined by the backlight mapping module 121.

In some embodiments, the system shown in FIG. 11 combines a backlight selection module 114, dependent upon image content, with a backlight perceptual white calculation module 119. The relative backlight selected by the BLS module 114 and the backlight selected by the perceptual white calculation module 119 may be multiplied and the result may be clipped to the range of the display backlight as expressed in Equation 8.

Backlightₚₐₙₑₗ=Clip_{Display}_{_{—}}_{Min&Max}(White_{Perceptual}·RelativeBacklight_{BP-BLS}) Equation 8 Backlight Mapping

### Ambient Adaptive Display Behavior

In some embodiments, the behavior of the resulting system may be summarized in Table 1 below. The term “contrast matching” refers to a characteristic of a tone curve created by shifting the tone curve up or down to avoid clipping. This shift preserves the slope of the curve and hence the local contrast which would be lost by clipping. Contrast matching may shift the tone curve away from a target tone curve thereby preventing a perfect lightness match. The term “lightness matching” refers to a characteristic of a tone curve created when the tone curve overlays or follows a target tone curve. A “near lightness match” is achieved when the tone curve is shifted only a small amount to provide some contrast matching and only a small offset from the target tone curve. Specific embodiments of these characteristics are described in more detail below. Plots showing the display response to different situations are also provided below.

TABLE 1
Exemplary System Operations

| | Content | | |
|---|---|---|---|
| Ambient | Dark | Mid | Bright |
| Low | Contrast Match | Near Lightness Match | Lightness Match |
| | (Increased | (Increased Lightness) | |
| | Lightness) | | |
| Medium | Lightness Match | Lightness Match | Lightness Match |
| High | Lightness Match | Near Lightness Match | Contrast Match |
| | | (Decreased Lightness) | (Decreased |
| | | | Lightness) |

In some embodiments corresponding to Table 1, the range of ambient illumination sensed by the ambient illumination sensor 123 is quantized into three levels, low, medium and high. The range of image characteristics is also quantized into three categories representing dark, mid-brightness and bright. In other embodiments, a finer quantization of ambient illumination and image characteristics may be used. Additionally, when a color ambient illumination sensor 123 is used, the color of the ambient illumination may be used in the selection of a tonescale or gain operation. In the exemplary embodiment corresponding to Table 1, the operations performed for various image content brightness levels at the described ambient illumination levels are as follows:
Low Ambient: For dark content, the contrast is matched but the absolute lightness is elevated due to the lower limit on the display capability, i.e. elevated black level. For mid-brightness images, the contrast is preserved with a small increase in lightness necessary to enable contrast preservation. For bright images, lightness matching is achieved.
Medium Ambient: For all content, a lightness match is achieved over a wide range of image code values with the exception of elevated low code values of bright images and lowered large code values of dark images.
High Ambient: For dark content, a lightness match is achieved. For mid-brightness images, the contrast is preserved with a small decrease in lightness due to limits on the display backlight. For bright content, the contrast is matched but the absolute lightness is lowered due to the upper limit on the display capabilities, i.e. limit on maximum backlight.

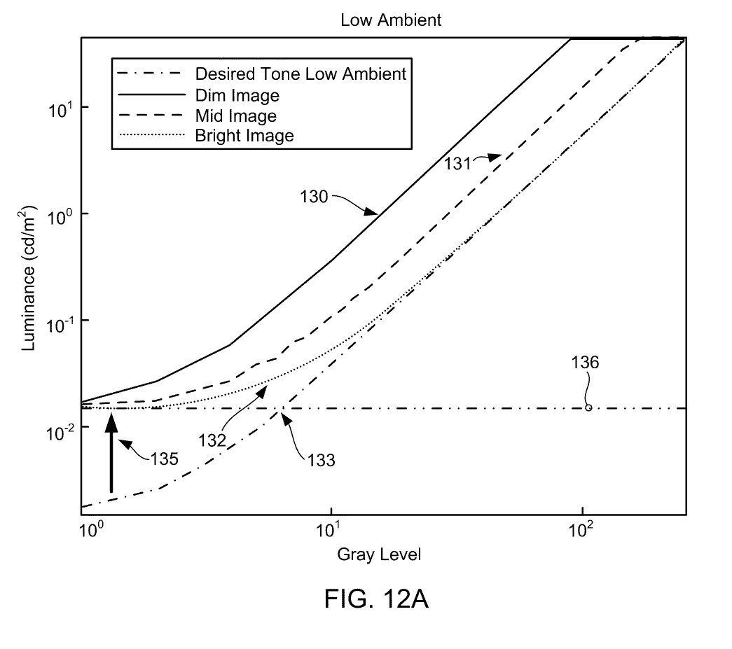

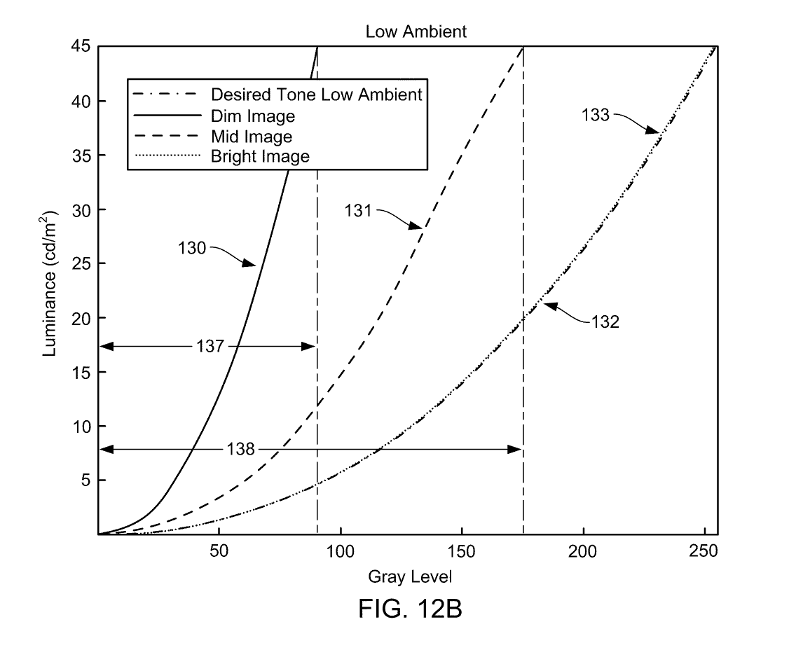

FIGS. 12A-14B compare exemplary resultant tone curves for low, mid, and high-ambient conditions. Display curves may be derived from the model described above and the constraints on the display capabilities. The different line types each indicate the resultant tone curve for a different class of input image, wherein the classes are dependent on the lightness of the image content. In some embodiments, image content lightness may be based on an average gray level for an image, an image histogram or other image characteristics, such as those described in reference incorporated herein by reference. The differences between curves illustrate the design goals described above wherein lightness matching is traded off for contrast-preservation. The differences across light levels illustrate the ambient-adaptive behavior of the algorithm. The result is that, based upon the content, different areas of the desired tone curve may be emulated.

FIG. 12A illustrates tone curves in a log-log plot for a low ambient illumination condition. FIG. 12B illustrates the same tone curves in a linear plot. FIG. 12A shows more detail on the low end of the luminance scale with the log-log plot where the actual tone curves 130-132 are shifted 135 upscale to allow “contrast matching.” A target tone curve 133 represents the desired tone curve relationship for a low ambient illumination condition. Horizontal line 136 represents a lower limit in display capability that may or may not exist due to a reduced backlight setting.

“Contrast matching” is a process whereby clipping, due to display constraints or otherwise, is prevented by shifting the tone curve to within the display limit for the condition for which the tone curve applies. If the target tone curve 133 were used, clipping would occur for a range of values at the low end of the luminance range below the display limit 136, however, shifting 135 the tone curve upscale prevents clipping and the associated contrast loss and effects a contrast preservation or “contrast matching” operation.

In some embodiments of the present invention, under conditions of low ambient illumination, when image content is dim or dark a dim image/low ambient tone curve 130 may be selected. When image content is mid-level, a mid image/low ambient tone curve 131 may be selected. When image content is bright, a bright image/low ambient tone curve 132 may be selected. Each of these actual low ambient tone curves 130-132 provides contrast matching or preservation at low image code values, but each curve varies above these low values as is shown in FIG. 12B and described in Table 1. In some embodiments, dim image/low ambient tone curve 130, in addition to contrast matching, may provide increased lightness in a low range 137 of dim image gray levels in comparison to other low ambient tone curves 131, 132. This expansion may also be characterized by an increased tone curve slope in this low range 137 in relation to the low ambient tone curves for brighter images 131, 132. In some embodiments, mid image/low ambient tone curve 131, in addition to contrast matching, may provide mildly increased lightness (but less than the increased lightness of dim image/low ambient tone curve 130) of a mid range 138 of gray levels in comparison to bright image/low ambient tone curve 132. This relationship may also be characterized by an increased tone curve slope in relation to low ambient tone curves for brighter images 132. In some embodiments, bright image/low ambient tone curve 132, in addition to contrast matching at the low end of the curve, may follow the target tone curve 133 for a significant part of its range.

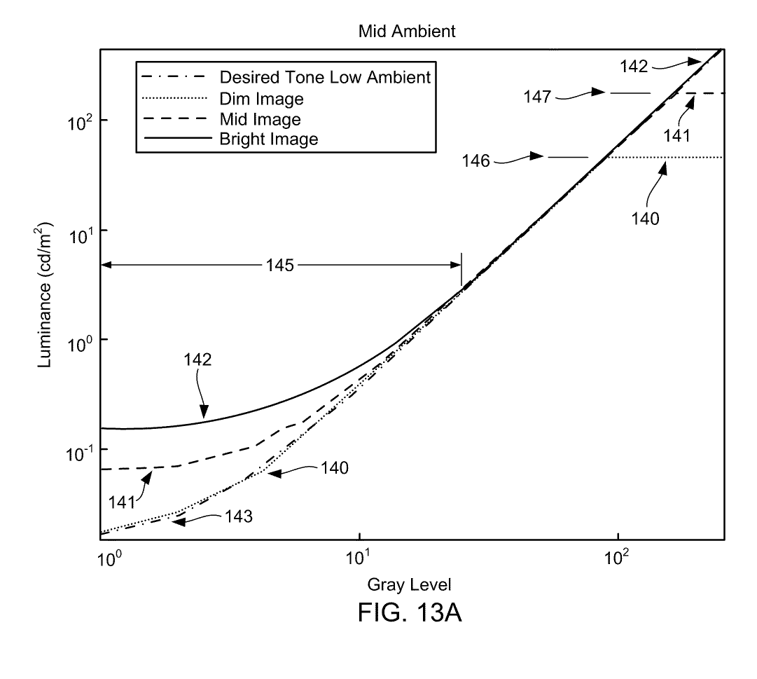

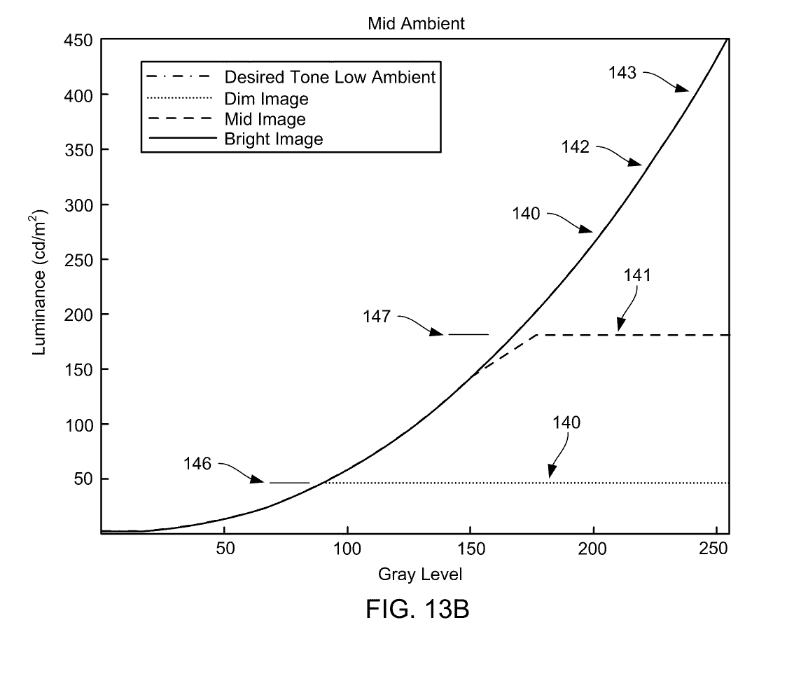

In some embodiments of the present invention illustrated in FIGS. 13A and 13B, under conditions of moderate or mid ambient illumination, when image content is dim or dark a dim image/mid ambient tone curve 140 may be selected. When image content is mid-level, a mid image/mid ambient tone curve 141 may be selected. When image content is bright, a bright image/mid ambient tone curve 142 may be selected. Each of these actual mid ambient tone curves 140-142 provides a small amount of contrast preservation at low image code values 145, as shown in FIG. 13A. Above these low values, each curve follows the target tone curve 143, thereby providing “lightness matching” for various ranges until clipping occurs. In some embodiments, dim image/mid ambient tone curve 140, may provide lightness matching up to a dim image lightness match limit 146. In some embodiments, clipping may occur at this limit. In some embodiments, mid image/mid ambient tone curve 141, may provide lightness matching up to a mid image lightness match limit 147. In some embodiments, bright image/mid ambient tone curve 142 may follow mid ambient target tone curve 143 up to a maximum code value thereby providing lightness matching up to the maximum code value.

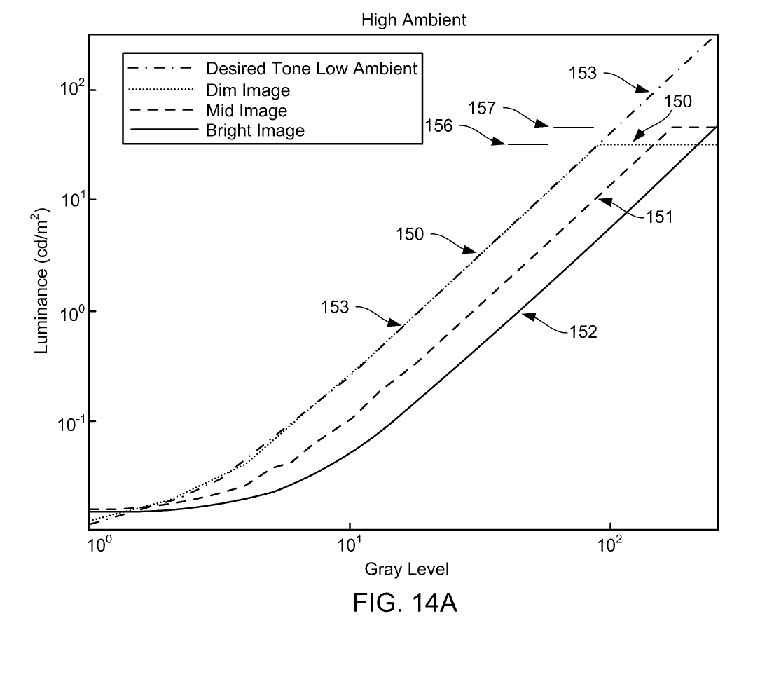

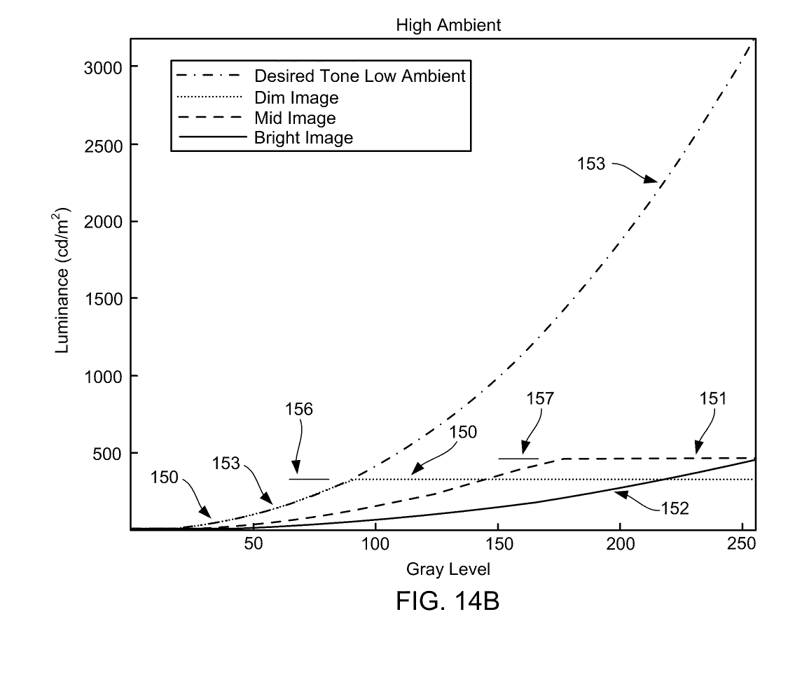

In some embodiments of the present invention illustrated in FIGS. 14A and 14B, under conditions of bright ambient illumination, when image content is dim or dark a dim image/bright ambient tone curve 150 may be selected. When image content is mid-level, a mid image/bright ambient tone curve 151 may be selected. When image content is bright, a bright image/bright ambient tone curve 152 may be selected. A bright ambient target tone curve 153 is also shown in FIGS. 14A and 14B.

In some embodiments, a dim image/bright ambient tone curve 150 may provide lightness matching by following a bright image target tone curve up to a bright image lightness match limit 156. Clipping may occur at this limit. In some embodiments, a mid image/bright ambient tone curve 151 may provide decreased lightness up to a mid image lightness match limit 147 where clipping may occur. In some embodiments, a bright image/bright ambient tone curve 152 may provide a further lightness decrease than the mid image/bright ambient tone curve 151, but will also provide contrast matching whereby image code values are not allowed to clip.

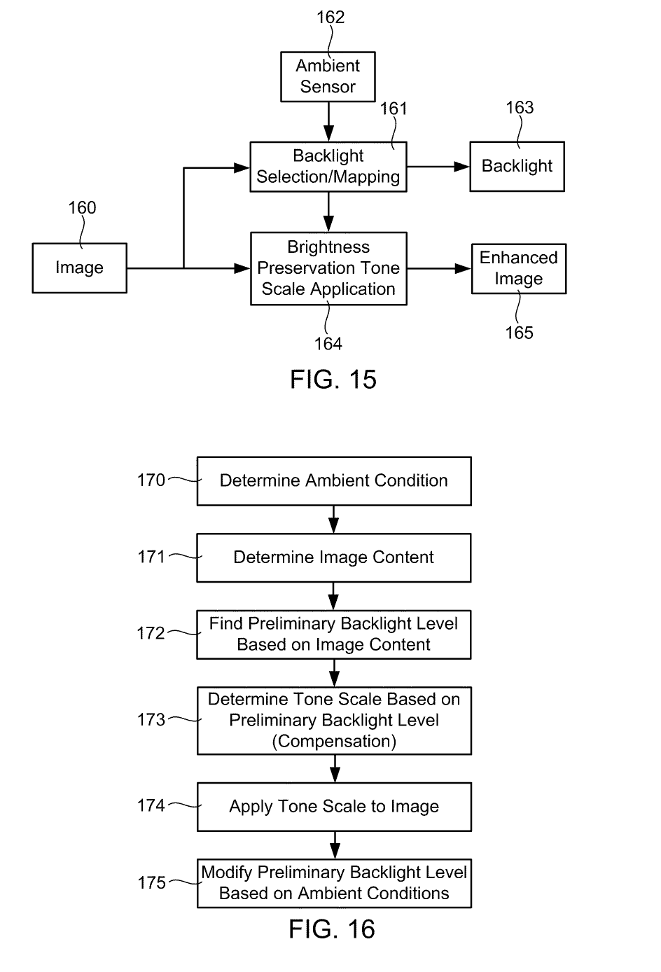

Some embodiments of the present invention may be described with reference to FIG. 15. In these embodiments, an ambient illumination sensor 162 provides input to a brightness preservation backlight selection and tonescale generation module (BPBT) 161. The BPBT 161 also receives input from the input image 160 as actual image data or image characteristic data derived from input image 160. In some embodiments, a separate module may analyze input image 160 and provide image analysis data, e.g., a histogram, average gray level or other data, to the BPBT 161. Based on the ambient conditions received from ambient sensor 162 and image data received from input image 160, the BPBT 161 may calculate an appropriate backlight selection that may be sent to the display backlight 163 for use in displaying input image 160 or an enhanced version thereof. The BPBT 161 may also generate a tone scale curve that is dependent on both the ambient conditions and the image content. The tone scale curve may be sent to a tone scale application module 164 for image modification. The image produced by applying the tone scale to the image 160 is an enhanced image 165, which may be displayed with the selected backlight level used in backlight 165.

Some embodiments of the present invention may be described with reference to FIG. 16. In these embodiments, an ambient illumination condition is determined 170. Image content characteristics are also determined 171. Based on the image content a preliminary backlight selection is determined 172. A tone scale curve is generated 173 based on the preliminary backlight selection 172. This tone scale curve is then applied 174 to an input image thereby generating an enhanced image. The preliminary backlight selection may then be modified 175 based on the ambient illumination condition. The modified backlight selection may then be used to display the enhanced image.

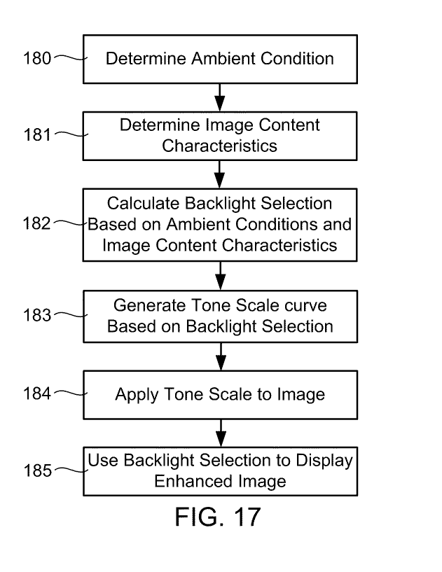

Some embodiments of the present invention, may be described with reference to FIG. 17. In these embodiments, an ambient illumination condition is determined 180. Image content characteristics are also determined 181. Based on the ambient illumination condition and image content a backlight selection is determined 182. A tone scale curve is generated 183 based on the backlight selection 182. This tone scale curve is then applied 184 to an input image thereby generating an enhanced image. The backlight selection may then be used 185 to display the enhanced image.

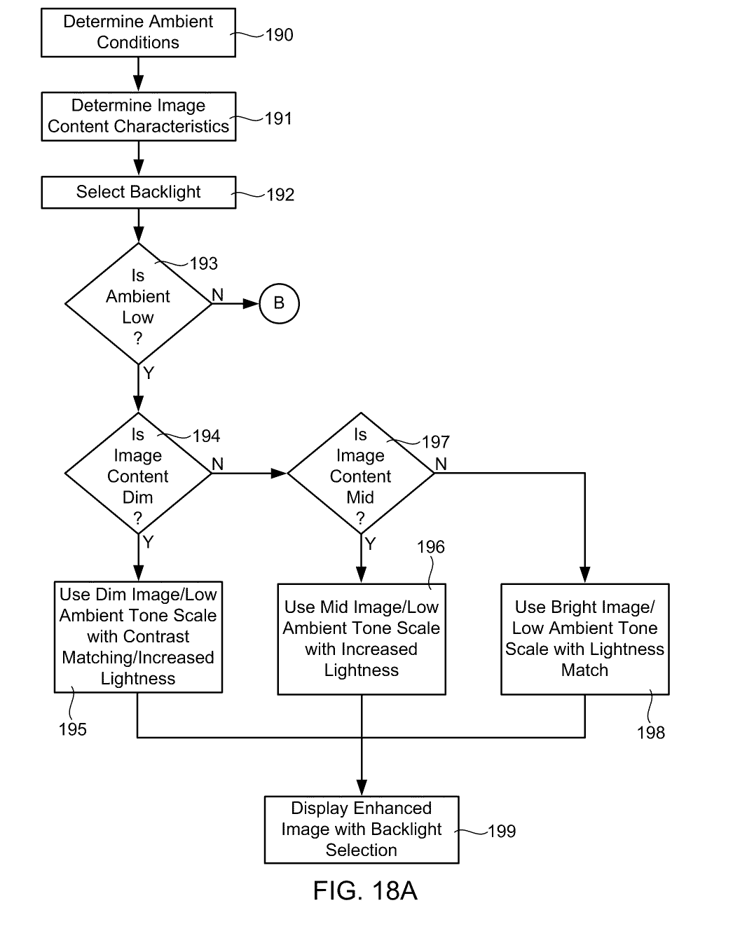

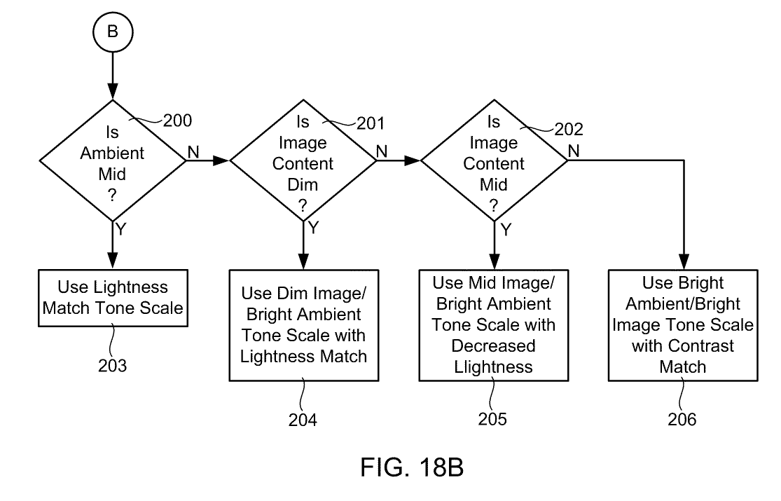

Some embodiments of the present invention may be described with reference to FIGS. 18A and 18B. In these embodiments, an ambient illumination condition is determined 190. Image content characteristics may also be determined 191. A display source light, such as a backlight, illumination condition or level may then be determined 192 based on the ambient illumination condition and the image content characteristics.

A tone scale curve, for application to the image on which the image content characteristics were determined 191, may then be selected or calculated based on the ambient condition and the image content characteristics.

In these embodiments, if the ambient illumination condition indicates that the ambient light intensity is low 193, the image content characteristic is evaluated to determine what tone scale process to apply. If the image content is dim 194, a dim image/low ambient tone scale with contrast matching and increased lightness is selected. If the image content is mid-range 196, a mid image/low ambient tone scale with increased lightness is selected. If the image content is bright 198, a bright image/low ambient tone scale with lightness matching is selected. If any of the above tone scale processes are selected, they are then applied to the image and displayed using the backlight selected at 192.

If the ambient illumination condition indicates that the ambient light intensity is mid-range 203, a lightness matching tone scale process is selected, applied to the image and the enhanced image is displayed with the backlight level selected at 192.

If the ambient illumination condition indicates that the ambient light intensity is high, that is not low or mid-range, the image content is evaluated. If the image content is dim 201, a dim image/bright ambient tone scale process with lightness matching is selected 204. If the image content is mid-range 202, a mid image/bright ambient tone scale with decreased lightness 205 is selected. If the image content is bright, that is not dim or mid-range, a bright ambient/bright image tone scale process with contrast matching 206 is selected. These selected tone scale processes may then be applied to the image and the resulting enhanced image may be displayed using the backlight level selected at 192.

### Unmatched Compensation Embodiments

In some embodiments of the present invention, a tone scale process that matches the tone scale enhancement directly to the source light adjustment is not selected. In these embodiments, a tone scale adjustment process is selected that may overcompensate for a corresponding display source light reduction or that may brighten an image when no display source light reduction is used. Other variations may also be utilized in which the tone scale adjustment over-compensates or under-compensates for adjustments in the display source light, e.g., backlight, illumination level. LCDs and other display devices comprise a source light that illuminates an LC panel such that light is transmitted through the panel where it is filtered by LC pixels to register an image. Some displays may have a side light or a front light instead of or in addition to a backlight. All of these backlights, side lights and front lights may be referred to a display source lights. In some cases, the term backlight may refer generically to any type of source light including a side light and front light.

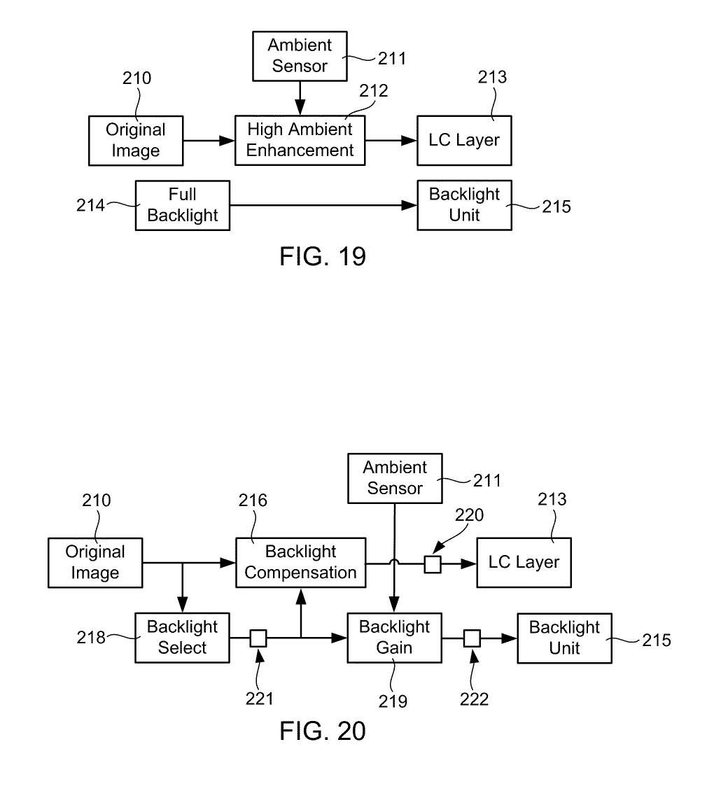

Some embodiments of the present invention may be described with reference to FIG. 19. In these embodiments, an ambient condition sensor 211 detects an ambient condition such as the intensity of ambient light at the location of a display device. Ambient conditions may comprise ambient illumination intensity, ambient illumination color and other ambient conditions. In some embodiments an ambient illumination intensity may be considered dim if the intensity is less than about 50 lux. In some embodiments, an ambient illumination intensity may be considered mid-range (mid) when the illumination intensity is between about 50 lux and about 500 lux. In some embodiments, an ambient illumination intensity may be considered high or bright when the illumination intensity is above about 500 lux. An ambient illumination intensity value may be characterized as dim, mid or bright by the ambient sensor 211, by the ambient enhancement module 212 or another component of the system.

The ambient condition sensor 211 may send ambient condition data to a high ambient enhancement module 212. The ambient enhancement module 212 may receive an input image 210 and apply a tone scale curve, gain function or another process to enhance the brightness of the image when the ambient condition sensor 211 indicates that the ambient illumination is high or bright. The enhanced image produced by this application of this curve, function or process may then be sent to an LC display layer 213 for display using a display source light or display backlight. In these embodiments, the backlight setting that is used for high or bright ambient conditions is a full backlight setting 214, which is sent to the display backlight unit 215 for use with the enhanced image.

Some embodiments of the present invention may be described with reference to FIG. 20. In these embodiments, an ambient condition sensor 211 detects ambient light conditions, such as an ambient illumination intensity. The ambient condition sensor 211 may report data to a ambient enhancement module 217, which is optional in some embodiments, and to a backlight gain module 219. A backlight compensation module 216 receives an input image 210 and receives an initial backlight selection 221 from a backlight selection module 218. The backlight compensation module 216 determines a tone scale curve or another process that will compensate the image for any backlight adjustment that occurs due to the initial backlight selection 221. The result of the backlight compensation module 216 is a backlight compensated image 220 wherein the process applied by the backlight compensation module 216 compensates for a backlight adjustment selected by the backlight selection module 218 for at least a portion of an image code value brightness range.

In some embodiments, a backlight gain module 219 may receive ambient condition data from an ambient sensor 211 and modify an initial backlight selection 221 in response to the ambient condition data thereby producing an ambient-adapted backlight selection 222. In some embodiments, the initial backlight setting 221 may be increased when ambient conditions are bright, such that the ambient-adapted backlight setting 222 is higher than the initial backlight setting 221. In this case, the input image 210 has been compensated for the initial backlight setting 221, thereby producing a backlight compensated image 220 that will display at normal brightness (for at least a portion of the code value range). However, since the initial backlight setting 221 has been increased via the backlight gain module 219, a brighter ambient-adapted backlight setting 222 is used with the backlight compensated image 220 resulting in a brighter image being displayed.

In these embodiments, the backlight compensated image 220 is sent to the LC layer of the display 213 where it is used to modulate pixel settings on the LC panel. Correspondingly, the ambient-adapted backlight setting 222 is sent to the display backlight/source light unit 215 to modulate the backlight while the backlight compensated image 220 is displayed.

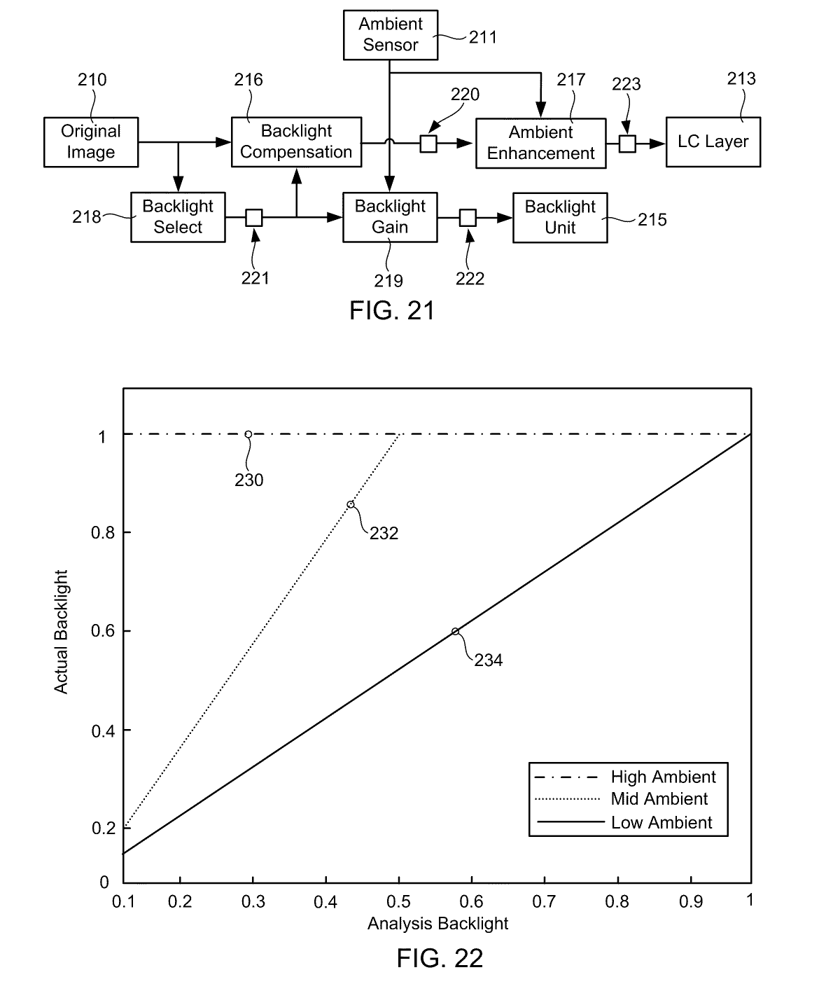

Some embodiments of the present invention may be described with reference to FIG. 21. These embodiments are similar to those described in relation to FIG. 20, except that these embodiments additionally comprise a ambient enhancement module 217. In these embodiments, the backlight compensated image 220 may be further modified by a ambient enhancement module 217. The ambient enhancement module 217 receives ambient condition data from the ambient sensor 211 and modifies the incoming backlight compensated image 220 when ambient conditions indicate modification is needed. In some embodiments, when a bright ambient illumination condition is detected, the ambient enhancement module 217 may apply a tone scale curve, gain function or other process to the backlight compensated image 220 to modify the backlight compensated image 220 independently of the backlight setting. Accordingly, a backlight-independent, ambient-condition-dependent modification is effected. The result of this process is an ambient-adapted, backlight compensated image 223.

In these embodiments, the ambient-adapted, backlight compensated image 223 is sent to the LC layer of the display 213 where it is used to modulate pixel settings on the LC panel. Correspondingly, the ambient-adapted backlight setting 222 is sent to the display backlight/source light unit 215 to modulate the backlight while the ambient-adapted, backlight compensated image 223 is displayed.

Aspects of some embodiments of the present invention may be described with reference to FIG. 22. FIG. 22 is a plot showing representative performance of an exemplary backlight gain function for low, mid and high ambient levels. This backlight gain function may be applied to the initial backlight selection 221 in the backlight gain module 219. At low ambient levels, the low ambient backlight gain function 234 does not modify the initial backlight selection 221. This setting allows the power savings provided by the initial backlight selection 221. In high ambient conditions, the backlight gain module 219 uses a backlight gain function 230, which sets the backlight to a maximum level regardless of the initial backlight setting 221. In this condition, the backlight compensation module 216 may still modify the input image 210 to provide increased brightness since the backlight compensation module 216 is operating on the initial backlight setting 221.

At mid ambient levels, a mid ambient backlight gain function 232 may be applied. The mid ambient backlight gain function 232 provides a brightness increase to the initial backlight setting, which was selected by the backlight selection module 218 based on image characteristics. Backlight brightness modification performed by the backlight gain module 219 is dependent on the ambient conditions only and is independent of image characteristics.

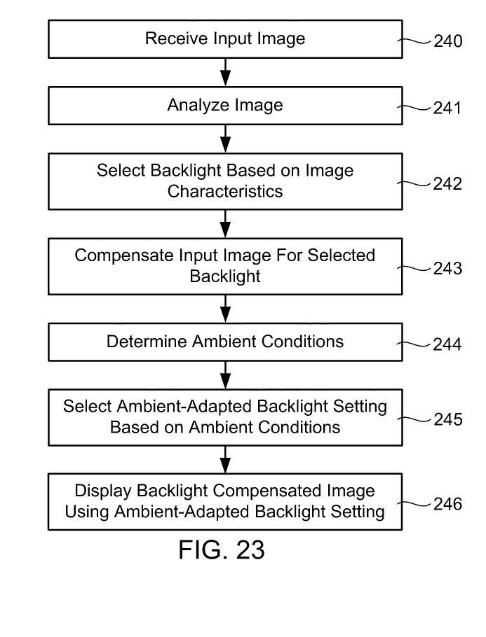

Some embodiments of the present invention may be described with reference to FIG. 23. In these embodiments, an input image is received 240 and analyzed 241 to determine image characteristics. An initial backlight setting is then selected, calculated or otherwise determined 242 based on image characteristics. Based on the initial backlight setting, an image compensation process, such as a tone scale curve, gain function, another process or a combination of processes may be determined and applied 243 to the input image, thereby creating a backlight compensated image.

Ambient conditions are determined 244, such as ambient illumination intensity, ambient illumination color and other ambient illumination characteristics. The initial backlight setting may then be adjusted or adapted 245 to account for ambient conditions. In some embodiments, this adjustment 245 may comprise setting the backlight to a maximum level when ambient conditions are bright. In some embodiments, this adjustment 245 may comprise application of a gain function that will increase backlight brightness for mid ambient illumination levels. In some embodiments, this adjustment 245 may comprise maintaining the initial backlight setting when low ambient illumination levels occur.

Once the initial backlight setting has been reviewed based on ambient conditions and adjusted 245, when needed, the ambient-adapted backlight setting may be sent to the backlight unit for use when displaying 246 the backlight compensated image.

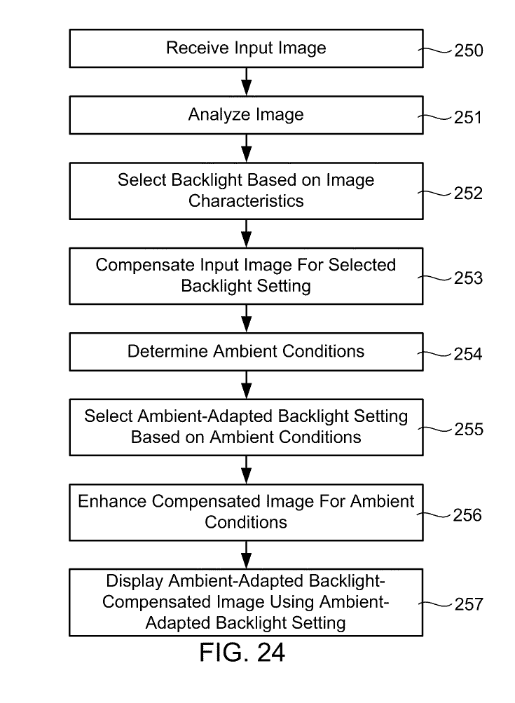

Some embodiments of the present invention may be described with reference to FIG. 24. In these embodiments, an input image is received 250 and analyzed 251 to determine image characteristics. An initial backlight setting is then selected, calculated or otherwise determined 252 based on image characteristics. Based on the initial backlight setting, an image compensation process, such as a tone scale curve, gain function, another process or a combination of processes may be determined and applied 253 to the input image, thereby creating a backlight compensated image.

Ambient conditions are determined 254, such as ambient illumination intensity, ambient illumination color and other ambient illumination characteristics. The initial backlight setting may then be adjusted 255 to account for ambient conditions. In some embodiments, this adjustment 255 may comprise setting the backlight to a maximum level when ambient conditions are bright. In some embodiments, this adjustment 255 may comprise application of a gain function that will increase backlight brightness for mid ambient illumination levels. In some embodiments, this adjustment 255 may comprise maintaining the initial backlight setting when low ambient illumination levels occur.

In some embodiments, the backlight compensated image may also be modified 256 based on ambient conditions. In these embodiments, a tone scale curve, gain function or other process may be applied to the backlight compensated image to modify contrast, brightness or other attributes in response to ambient conditions. This ambient-adapted, backlight-compensated image may then be sent to the LC layer or similar component of a display for display 257 using the ambient-adapted backlight setting.

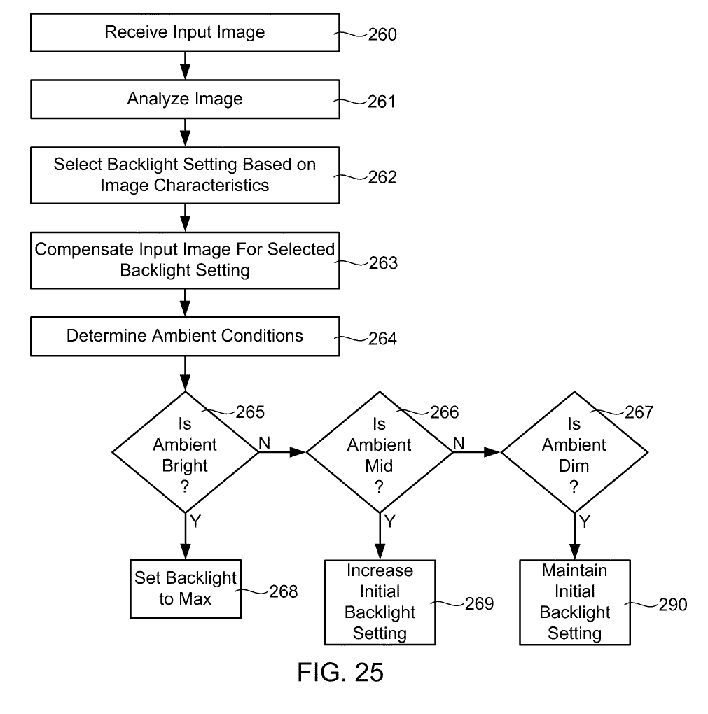

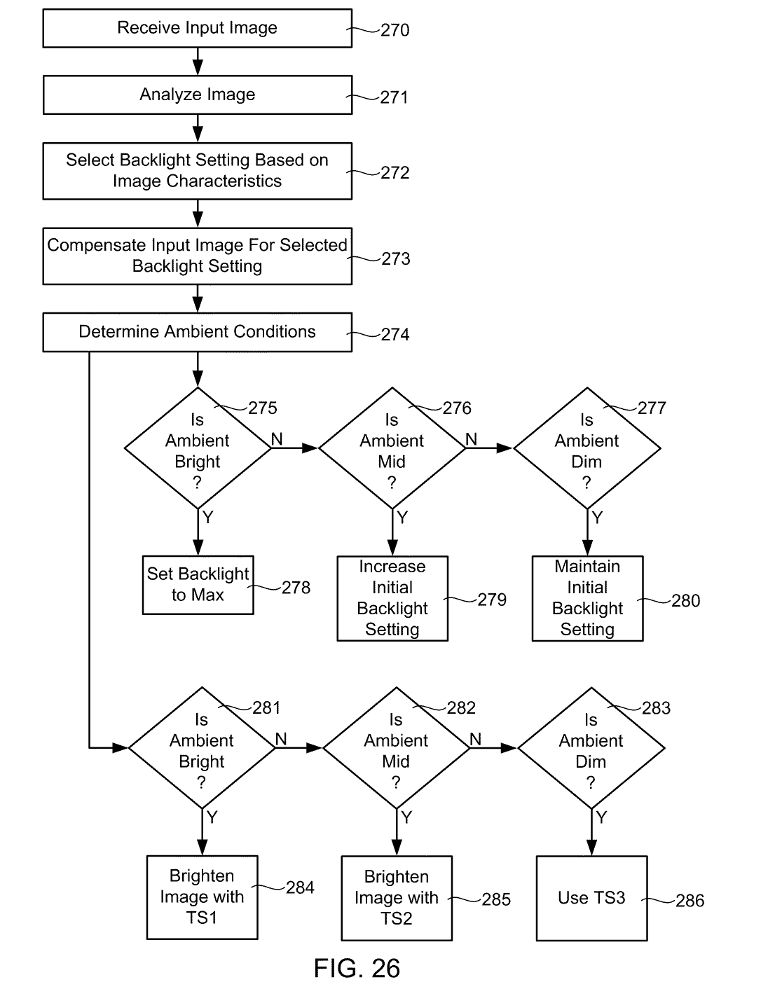

Some embodiments of the present invention may be described with reference to FIG. 25. In these embodiments, an input image is received 260 and analyzed 261 to determine image characteristics. An initial backlight setting is then selected, calculated or otherwise determined 262 based on image characteristics. Based on the initial backlight setting, an image compensation process, such as a tone scale curve, gain function, another process or a combination of processes may be determined and applied 263 to the input image, thereby creating a backlight compensated image.

Ambient conditions are determined 264, such as ambient illumination intensity, ambient illumination color and other ambient illumination characteristics. The initial backlight setting may then be adjusted to account for ambient conditions. In some embodiments, it may be determined whether the ambient conditions indicate a bright ambient illumination condition 265, if so, this adjustment will comprise setting the backlight to a maximum level 268. If the ambient conditions indicate that a mid-range ambient illumination condition exists 266, this adjustment will comprise application of a gain function that will increase backlight brightness 269. If the ambient conditions indicate that a dim ambient illumination condition exists 267, this adjustment will comprise maintaining the initial backlight setting 290.

Some embodiments of the present invention may be described with reference to FIG. 26. In these embodiments, an input image is received 270 and analyzed 271 to determine image characteristics. An initial backlight setting is then selected, calculated or otherwise determined 272 based on image characteristics. Based on the initial backlight setting, an image compensation process, such as a tone scale curve, gain function, another process or a combination of processes may be determined and applied 273 to the input image, thereby creating a backlight compensated image.

Ambient conditions are determined 274, such as ambient illumination intensity, ambient illumination color and other ambient illumination characteristics. The initial backlight setting may then be adjusted to account for ambient conditions. In some embodiments, it may be determined whether the ambient conditions indicate a bright ambient illumination condition 275, if so, this adjustment will comprise setting the backlight to a maximum level 278. If the ambient conditions indicate that a mid-range ambient illumination condition exists 276, this adjustment will comprise application of a gain function that will increase backlight brightness 279. If the ambient conditions indicate that a dim ambient illumination condition exists 277, this adjustment will comprise maintaining the initial backlight setting 280.

In these embodiments, the backlight compensated image may also be modified based on ambient conditions. In some embodiments, it may be determined whether the ambient conditions indicate a bright ambient illumination condition 281, if so, this adjustment will comprise the application of a first tone scale operation 284, which will brighten the image to a first extent. If the ambient conditions indicate that a mid-range ambient illumination condition exists 282, this adjustment will comprise application of a second tone scale operation 285 that will increase image brightness by a second extent that is less that the first extent. If the ambient conditions indicate that a dim ambient illumination condition exists 277, this adjustment may be avoided or may comprise the application of a third tone scale function that increases image brightness by a third extent that is less than the second extent.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for enhancing image display with ambient illumination input, said method comprising:
a) determining an ambient illumination condition near a display device;
b) determining an image content characteristic for an input image to be displayed;
c) calculating an initial backlight selection based on said image content characteristic;
d) determining a brightness compensation process to compensate said input image based on said initial backlight selection;
e) applying said brightness compensation process to said input image, thereby creating a backlight compensated image;
f) modifying said initial backlight selection based on said ambient illumination condition thereby creating an ambient-adapted backlight selection; and
g) modifying said backlight compensated image with a second brightness compensation process based on said ambient illumination condition, thereby creating an ambient-adapted, backlight-compensated image.

2. A method as described in claim 1 further comprising displaying said ambient-adapted, backlight compensated image using said ambient-adapted backlight selection.

3. A method as described in claim 1 wherein said modifying said initial backlight selection comprises setting said initial backlight selection to a maximum backlight intensity when said ambient illumination condition is bright, and.

4. A method as described in claim 1 wherein said modifying said initial backlight selection comprises setting said initial backlight selection to an increased value when said ambient illumination condition is mid-range.

5. A method as described in claim 1 wherein said modifying said initial backlight selection comprises maintaining said initial backlight selection at a current value when said ambient illumination condition is dim.

6. A method as described in claim 1 wherein said image content characteristic is a histogram.

7. A method as described in claim 1 wherein said modifying said initial backlight selection comprises a perceptual white point calculation.

8. A method as described in claim 1 wherein said modifying said initial backlight selection comprises applying a temporal filter.

9. A method for enhancing image display with ambient illumination input, said method comprising:
a) determining an ambient illumination condition near a display device;
b) determining an image content characteristic for an input image to be displayed;
c) calculating an initial backlight selection based on said image content characteristic;
d) determining a brightness compensation process to compensate said input image based on said initial backlight selection;
e) applying said brightness compensation process to said input image, thereby creating a backlight compensated image;
f) modifying said initial backlight selection based on said ambient illumination condition, wherein said modifying results in an ambient-adapted backlight selection and said modifying comprises setting said initial backlight selection to a maximum backlight intensity when said ambient illumination condition is bright, setting said initial backlight selection to an increased value when said ambient illumination condition is mid-range and maintaining said initial backlight selection at a current value when said ambient illumination condition is dim.

10. A method as described in claim 9 further comprising modifying said backlight compensated image with a second brightness compensation process based on said ambient illumination condition, thereby creating an ambient-adapted, backlight-compensated image.

11. A method as described in claim 9 wherein said determining an ambient illumination condition comprises determining whether ambient luminance intensity falls within a luminance category.

12. A method as described in claim 9 wherein said determining an image content characteristic comprises determining whether a brightness characteristic of said input image falls within a brightness category.

13. A method as described in claim 9 wherein said determining a brightness compensation process comprises selecting from a plurality of tone scale curves that correspond to various combinations of values for said image content characteristic.

14. A method as described in claim 10 wherein said modifying said backlight compensated image with a second brightness compensation process based on said ambient illumination condition comprises applying a first tone scale operation to said brightness compensated image to brighten said image to a first extent when said ambient illumination condition is bright.

15. A method as described in claim 14 wherein said modifying said backlight compensated image with a second brightness compensation process based on said ambient illumination condition further comprises applying a second tone scale operation to said brightness compensated image to brighten said image to a second extent, when said ambient illumination condition is mid-range.

16. A method as described in claim 15 wherein said modifying said backlight compensated image with a second brightness compensation process based on said ambient illumination condition comprises applying a third tone scale operation to said brightness compensated image to brighten said image to a third extent when said ambient illumination condition is dim.

17. A method for enhancing image display with ambient illumination input, said method comprising:
a) determining an ambient illumination condition near a display device;
b) determining an image content characteristic for an input image to be displayed;
c) calculating an initial backlight selection based on said image content characteristic;
d) determining a brightness compensation process to compensate said input image based on said initial backlight selection;
e) applying said brightness compensation process to said input image, thereby creating a backlight compensated image;
f) modifying said initial backlight selection based on said ambient illumination condition, wherein said modifying results in an ambient-adapted backlight selection and said modifying comprises setting said initial backlight selection to a maximum backlight intensity when said ambient illumination condition is bright, setting said initial backlight selection to an increased value when said ambient illumination condition is mid-range and maintaining said initial backlight selection at a current value when said ambient illumination condition is dim; and
g) modifying said backlight compensated image based on said ambient illumination condition, thereby creating an ambient-adapted, backlight-compensated image.

18. A method as described in claim 17 wherein said modifying said backlight compensated image with a second brightness compensation process based on said ambient illumination condition comprises applying a first tone scale operation to said brightness compensated image to brighten said image to a first extent when said ambient illumination condition is bright.

19. A method as described in claim 18 wherein said modifying said backlight compensated image with a second brightness compensation process based on said ambient illumination condition comprises applying a second tone scale operation to said brightness compensated image to brighten said image to a second extent that is less bright than said first extent, when said ambient illumination condition is mid-range.

20. A method as described in claim 19 wherein said modifying said backlight compensated image with a second brightness compensation process based on said ambient illumination condition comprises avoiding modification of said backlight compensated image when said ambient illumination condition is dim.
